(19) United States
(12) Patent Application Publication
(10) Pub. No.: US 2026/0066783 A1
(43) Pub. Date: Mar. 5, 2026

(54) Charge Pump Circuit And Charge Pump Boosting Method For Faster Settling

(71) Applicant: MediaTek Inc., Hsinchu City (TW)

(72) Inventor: Amine Tagant, Cambridge (GB)

(73) Assignee: MediaTek Inc., Hsinchu City (TW)

(21) Appl. No.: 19/306,911

(22) Filed: Aug. 21, 2025

Related U.S. Application Data
(60) Provisional application No. 63/689,018, filed on Aug. 30, 2024.

(51) Int. Cl. H02M 3/07

(52) U.S. Cl. CPC H02M 3/07

(57) ABSTRACT

Various solutions for the charge pump circuit are described. A charge pump circuit may include one or more stages of main charge pump. Each stage of main charge pump may be coupled in series. The charge pump circuit may also include a plurality of booster transistors. Each booster transistor may be respectively coupled to each transistor of the one or more stages of main charge pump. Each booster transistor may be enabled to provide a booster voltage in an event that the charge pump circuit is coupled to a load.

### CROSS REFERENCE TO RELATED PATENT APPLICATIONS

The present disclosure is part of a non-provisional application claiming the priority benefit of U.S. Patent Application No. 63/689,018, filed 30 August 2024, the content of which herein being incorporated by reference in its entirety.

### TECHNICAL FIELD

The present disclosure is generally related to circuit design enhancement and, more particularly, to charge pump boosting with respect to charge pump circuit.

### BACKGROUND

Unless otherwise indicated herein, approaches described in this section are not prior art to the claims listed below and are not admitted as prior art by inclusion in this section.

In conventional charge pump technologies, the charge pump circuit may be used to drive (or charge) a load (e.g., switches, capacitors, resistor–capacitor (RC) networks, and so on). However, in an event that the load comprises large devices (e.g., large RC filters and transistors), a higher current may be drawn from the output of the charge pump circuit. That is, when the load is connected via a switch, high current flows but only until the load charges (capacitive load), making the charge pump output collapse. The higher current may cause the charge pump circuit to fully discharge the pumping capacitors. In addition, the higher current may create a non-negligible IR drop (due to the equivalent resistor (e.g., Rₒₙ of the cross-coupled transistors) of the charge pump circuit) across the cross-coupled transistors of the charge pump circuit. Therefore, the output voltage of the charge pump circuit may collapse and the charge pump will take much longer to recover. In addition, in an event that the charge pump circuit recovers for a long time, the charge pump circuit may not fulfill the speed requirements.

Accordingly, how to reduce the IR drop in the charge pump circuit in an event that a load is coupled to the charge pump circuit becomes an important issue for the newly developed charge pump circuit.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods, and apparatus pertaining to charge pump boosting with respect to charge pump circuit. It is believed that the above-described issue would be avoided or otherwise alleviated by implementing one or more of the proposed schemes described herein.

In one aspect, a charge pump circuit may involve one or more stages of main charge pump. Each stage of main charge pump may be coupled in series. The charge pump circuit may also involve a plurality of booster transistors. Each booster transistor may be respectively coupled to each transistor of the one or more stages of main charge pump. Each booster transistor may be enabled based on a booster voltage in an event that the charge pump circuit is coupled to a load.

In another aspect, a charge pump boosting method may involve a charge pump circuit. The charge pump circuit may comprise one or more stages of main charge pump and a plurality of booster transistors, wherein each stage of main charge pump is coupled in series, and wherein each booster transistor is respectively coupled to each transistor of the one or more stages of main charge pump. The charge pump boosting method may involve the charge pump circuit enabling each booster transistor to provide a booster voltage in an event that the charge pump circuit is coupled to a load. The charge pump boosting method may also involve the charge pump circuit disabling each booster transistor in an event that the load has been fully charged and a load current has been an idle value.

It is noteworthy that, although description provided herein may be in the context of circuit design in certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a two-stage charge pump circuit in which various solutions and schemes in accordance with the present disclosure may be implemented.

FIG. 2 is a diagram depicting an example scenario for a level shifter of a booster circuit in accordance with implementations of the present disclosure.

FIG. 3 is a diagram depicting an example scenario for a mini charge pump of a booster circuit in accordance with implementations of the present disclosure.

FIG. 4 is a time diagram depicting an example scenario for the internal and output voltages of the main charge pump in an idle load condition.

FIG. 5 is a time diagram depicting another example scenario for the internal and output voltages of the main charge pump under a higher load current condition without a booster.

FIG. 6 is a time diagram depicting an example scenario for the booster control voltages and the effect on the main charge pump output voltages in accordance with implementations of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to charge pump boosting with respect to charge pump circuit. According to the present disclosure, a number of possible solutions may be implemented separately or jointly. That is, although these possible solutions may be described below separately, two or more of these possible solutions may be implemented in one combination or another.

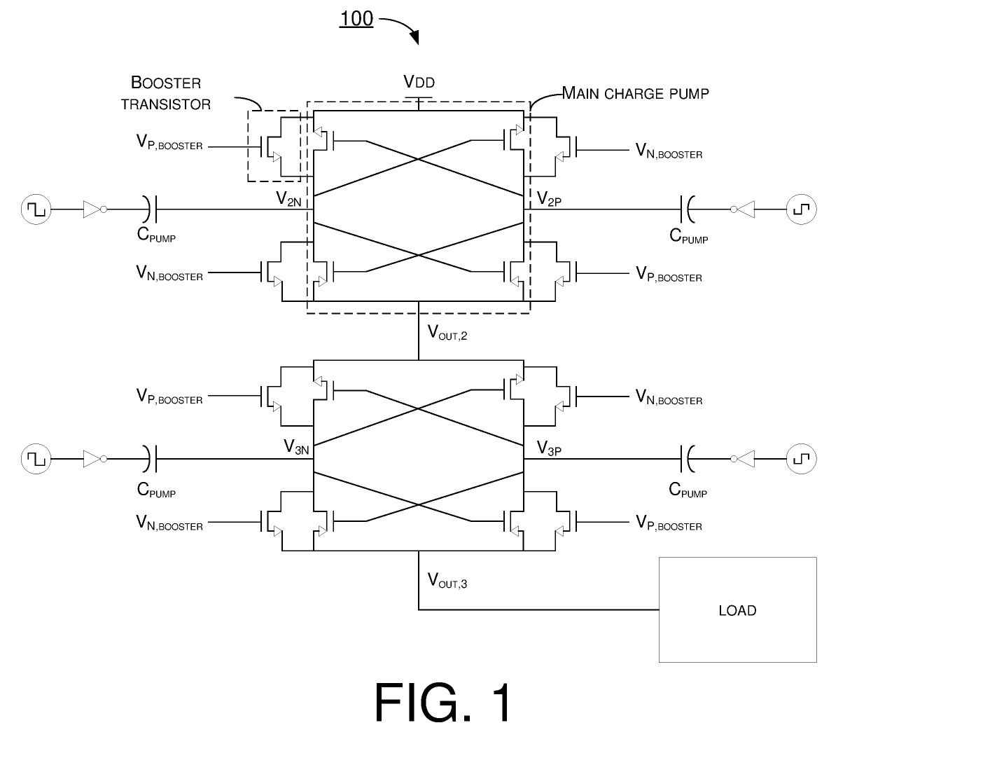

According to the implementations of the present disclosure, a charge pump circuit (e.g., charge pump circuit of FIG. 1) may comprise one or more stages of main charge pump (e.g., cross-coupled charge pump). Each stage of cross-coupled charge pump of the charge pump circuit may be coupled in series. In addition, the charge pump circuit may comprise a plurality of booster transistors. Each booster transistor of the charge pump circuit may be respectively coupled to each transistor of the one or more stages of cross-coupled charge pump of the charge pump circuit. Each booster transistor may be enabled based on a booster voltage in an event that the charge pump circuit is coupled to a load (e.g., switches, capacitors, resistor–capacitor (RC) networks, and so on). After the load has been fully charged (or charged enough) and the load current has been settled to an idle value (i.e., the load current is reduced and the IR drop is not problematic), the booster transistor may be disabled.

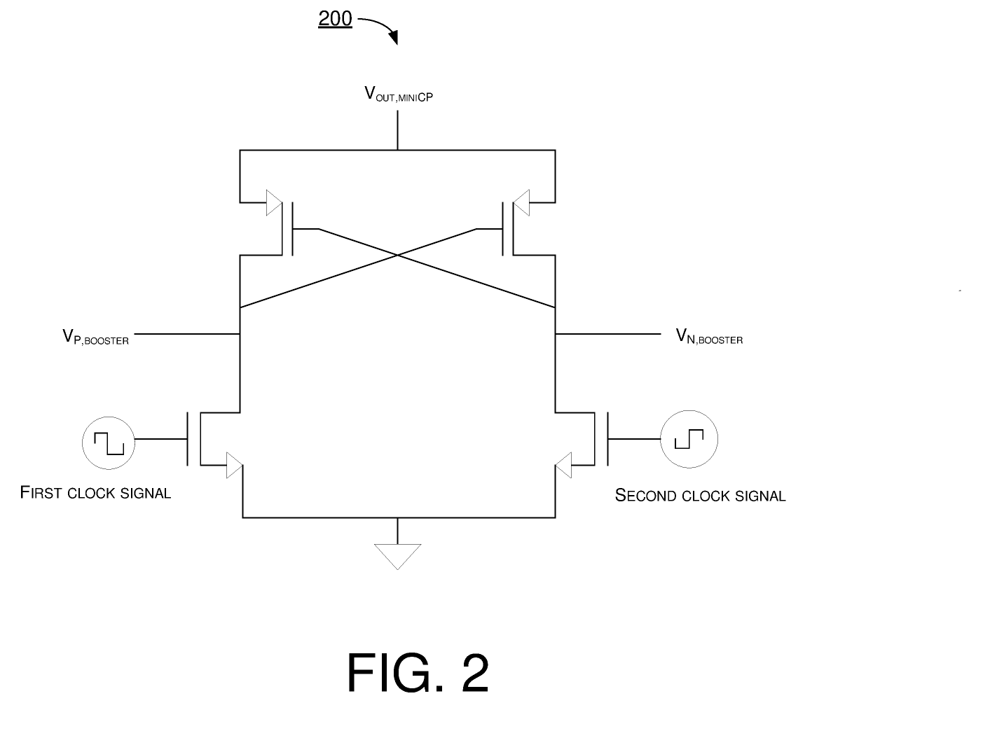

According to the implementations of the present disclosure, each booster transistor of the charge pump circuit may comprise an N-channel metal-oxide-semiconductor field-effect transistor (NMOS). In addition, each booster transistor of the charge pump circuit may receive the booster voltage (e.g., V_{P, booster} and V_{N, booster} shown in FIG. 1 and FIG. 2) from a level shifter (e.g., level shifter of FIG. 2). The booster transistors and the level shifter may be integrated in a booster circuit. In an event that the charge pump circuit is coupled to a load (e.g., switches, capacitors, resistor–capacitor (RC) networks, and so on), each booster transistor may be enabled to provide the booster voltage from the level shifter. That is, each booster transistor (or NMOS of each booster transistor) may be triggered (or driven) by the booster voltage from the level shifter.

According to the implementations of the present disclosure, the booster voltage may comprise an NMOS booster voltage or a P-channel metal-oxide-semiconductor field-effect transistor (PMOS) booster voltage. In an event that a gate of the NMOS of a booster transistor is triggered by the booster voltage, the gate-source voltage (i.e., V_{gs}) of the NMOS of the booster transistor may be higher than the gate-source voltage of the transistor of the cross-coupled charge pump coupled to the NMOS of the booster transistor.

FIG. 1 illustrates an example scenario 100 of a two-stage charge pump circuit in which various solutions and schemes in accordance with the present disclosure may be implemented. Referring to FIG. 1, the charge pump circuit may comprise two stages of main cross-coupled charge pump (i.e., main charge pump). The two stages of main cross-coupled charge pump may be coupled in series. Each stage of main cross-coupled charge pump may comprise two symmetrical paths operating based on two out-of-phase clock signals. Each inverter of the main cross-coupled charge pump may be used to drive one plate of the pumping (or flying) capacitor Cₚᵤₘₚ. The first main cross-coupled charge pump may generate the output voltage V_{out, 2} (e.g., 2*V_{DD}), and the second main cross-coupled charge pump may generate the output voltage V_{out, 3} (e.g., 3*V_{DD}). The internal voltage V_{2P} or V_{2N} of the first main cross-coupled charge pump may switch from V_{DD} to 2 * A_{CP} * V_{DD}. The internal voltage V_{3P} or V_{3N} of the second main cross-coupled charge pump may switch from V_{DD} to 3 * A_{CP} * V_{DD}. The A_{CP} may be defined as the voltage performance ratio, where A_{CP} = 1 – Aₗₒₛₛₑₛ, and Aₗₒₛₛₑₛ represents the losses. In the absence of losses, A_{CP} = 1.

In addition, referring to FIG. 1, the charge pump circuit may comprise a plurality of booster transistors. Each booster transistor of the charge pump circuit may be in parallel with the transistor of the cross-coupled charge pump of the charge pump circuit. Each booster transistor of the charge pump circuit may comprise an NMOS. In addition, each booster transistor of the charge pump circuit may receive the booster voltage (e.g., V_{P, booster} or V_{N, booster}) from a level shifter. In an event that the charge pump circuit is coupled to a load (e.g., switches, capacitors, resistor–capacitor (RC) networks, and so on), each booster transistor may be enabled to provide the booster voltage. In addition, in an event that a gate of the NMOS of a booster transistor is triggered by the booster voltage, the gate-source voltage (i.e., V_{gs}) of the NMOS of the booster transistor may be higher than the gate-source voltage of the transistor of the cross-coupled charge pump coupled to the NMOS of the booster transistor to reduce the IR drop on the equivalent resistor (e.g., Rₒₙ) of the cross-coupled charge pump. The booster transistor may be disabled (i.e., V_{P, booster} = 0 or V_{N, booster} = 0) in an event that the charge pump of the cross-coupled charge pumps (i.e., main cross-coupled charge pump) of the charge pump circuit recovers. Specifically, the booster enabling and the booster disabling may be determined based on the booster voltage from the level shifter. The booster enabling may mean that the level shifter may be driven by the clock signal with the same clocks as the main cross-coupled charge pump. Then, the input signal of the level shifter may be switched from ground (i.e., 0) to V_{out,}_{miniCP}, and the level shifter may generate the booster voltage V_{N,}_{booster} and V_{P,}_{booster}. The booster disabling may mean that the level shifter may be driven by the clock signal = 1. Therefore, V_{N,}_{booster} and V_{P,}_{booster} may be pulled to ground (i.e., V_{P, booster} = 0 or V_{N, booster} = 0) to turn off the booster transistor. According to the implementations of the present disclosure, a logic circuit (e.g., a Not END (NAND) gate) may be used to control the booster enabling and the booster disabling.

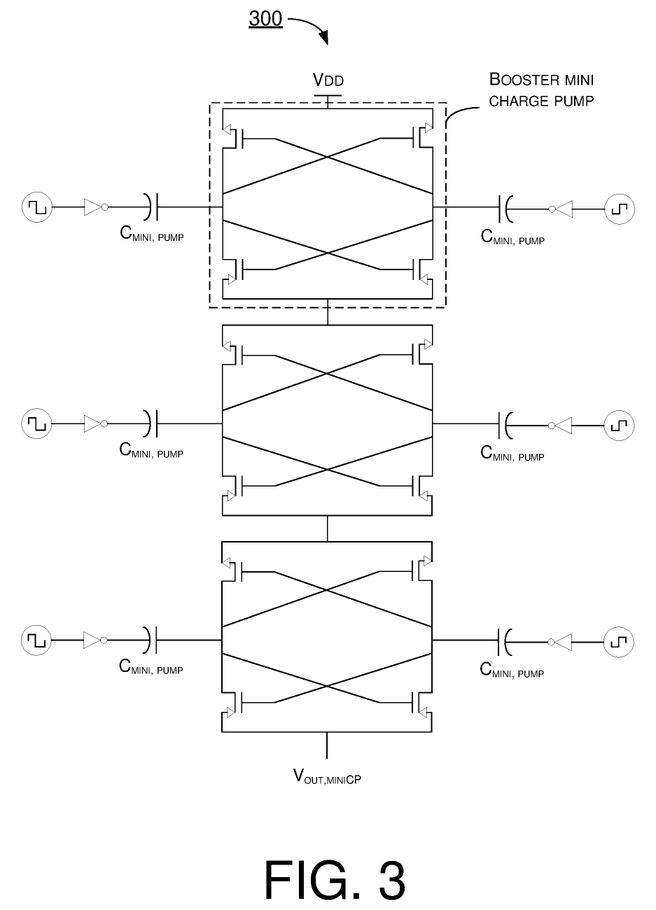

FIG. 2 illustrates an example scenario 200 of a level shifter of a booster circuit in which various solutions and schemes in accordance with the present disclosure may be implemented. Referring to FIG. 2, the level shifter may generate the booster voltage V_{P, booster} or the booster voltage V_{N, booster} in an event that the input signal is switched from ground to an output voltage (e.g., V_{out, miniCP}) from a mini charge pump circuit (e.g., mini charge pump circuit of FIG. 3). The level shifter may use the same clock signals (e.g., fist clock signal and second clock signal) as the charge pump circuit. The booster transistors, the level shifter, and the mini charge pump circuit may be integrated in a booster circuit.

In addition, referring to FIG. 2, the level shifter may comprise a first PMOS, a second PMOS, a first NMOS, and a second NMOS. The source of the first PMOS may be coupled to the source of the second PMOS. The gate of the first PMOS and the drain of the second PMOS may be coupled to the drain of the second NMOS. The gate of the second PMOS and the drain of the first PMOS may be coupled to the drain of the first NMOS. The source of the first NMOS may be coupled to the source of the second NMOS.

In addition, the source of the first PMOS and the source of the second PMOS of the level shifter may receive the output voltage from the mini charge pump circuit. The gate of the first NMOS of the level shifter may receive a first clock signal, and the gate of the second NMOS of the level shifter may receive a second clock signal. The first clock signal and the second signal may be out of phase. The level shifter may output the booster voltage (e.g., V_{P, booster} or V_{N, booster}) to each booster transistor according to the output signal, the first clock signal and the second clock signal. In addition, in an implementation, in an event that the booster transistors of the charge pump circuit need to be disabled, the first clock signal and the second clock signal may be changed (or forced) to 1 (or high) to make the booster voltage (e.g., V_{P, booster} or V_{N, booster}) be 0.

According to the implementations of the present disclosure, the mini charge pump circuit may comprise a plurality of stages of cross-coupled charge pump. In an implementation, the number of the stages of cross-coupled charge pump of the mini charge pump circuit (e.g., mini charge pump circuit of FIG. 3) may be more than the number of the stages of cross-coupled charge pump of the charge pump circuit (e.g., the charge pump circuit of FIG. 1) to match the output voltage of the main cross-coupled charge pump (i.e., the cross-coupled charge pumps of the charge pump circuit). In an implementation, each capacitance (e.g., C_{mini, pump} of FIG. 3) of the stages of cross-coupled charge pump of the mini charge pump circuit may be smaller than each capacitance (e.g., Cₚᵤₘₚ of FIG. 1) of the stages of cross-coupled charge pump of the charge pump circuit. Therefore, the layout area for the mini charge pump circuit can be saved.

FIG. 3 illustrates an example scenario 300 of a mini charge pump circuit of a booster circuit in which various solutions and schemes in accordance with the present disclosure may be implemented. Referring to FIG. 3, the mini charge pump circuit may comprise three stages of booster mini charge pump (e.g., three stages of mini cross-coupled charge pump). The number of stages of the booster mini charge pump (e.g., mini cross-coupled charge pump) of the mini charge pump circuit may be more than the number of stages of the main charge pump (e.g., main cross-coupled charge pump) of the charge pump circuit. For example, the charge pump circuit may only comprise a two-stage main cross-coupled charge pump. In addition, each capacitance C_{mini, pump} of the stages of booster mini charge pump of the mini charge pump circuit may be smaller than each capacitance (e.g., Cₚᵤₘₚ of FIG. 1) of the stages of main cross-coupled charge pump of the charge pump circuit. The mini charge pump circuit may generate the output voltage V_{out, miniCP}, and transmit the output voltage V_{out, miniCP} to the level shifter. The output voltage V_{out, miniCP} may be 3~4 V_{DD} based on the capacitance C_{mini, pump}.

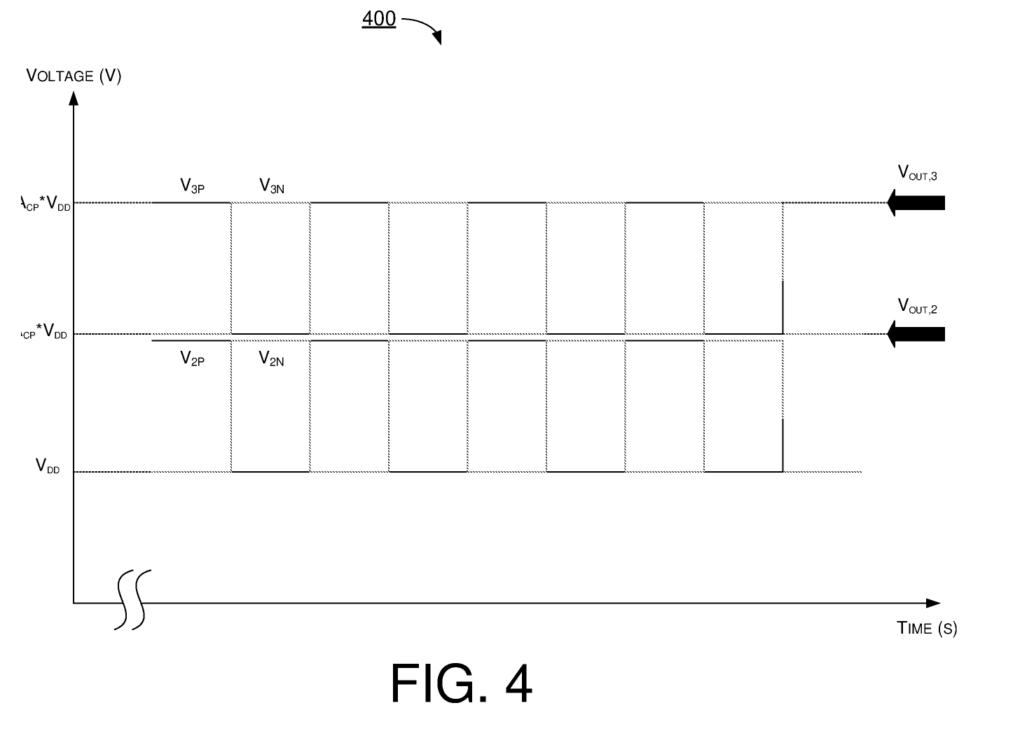

FIG. 4 illustrates an example scenario 400 of a time diagram for the internal and output voltages of the main charge pump in idle load condition. Referring to FIG. 4, in an event that the charge pump circuit is not coupled to a load or under an idle load (e.g., low load current), the first stage internal voltages (V_{2P} or V_{2N}) may be switched from V_{DD} to A_{CP} * V_{DD}. The A_{CP} is the voltage performance ratio and A_{CP} = 1 – Aₗₒₛₛₑₛ. The losses may comprise the IR drop of the transistors, Cₚᵤₘₚ voltage droop. In the absence of losses, A _{CP} = 1. The output voltage V_{out, 2} may be driven by the internal voltages V_{2P} or V_{2N} and sit at high level. The samp principle may be applied for the second stage and the output voltage V_{out, 3}.

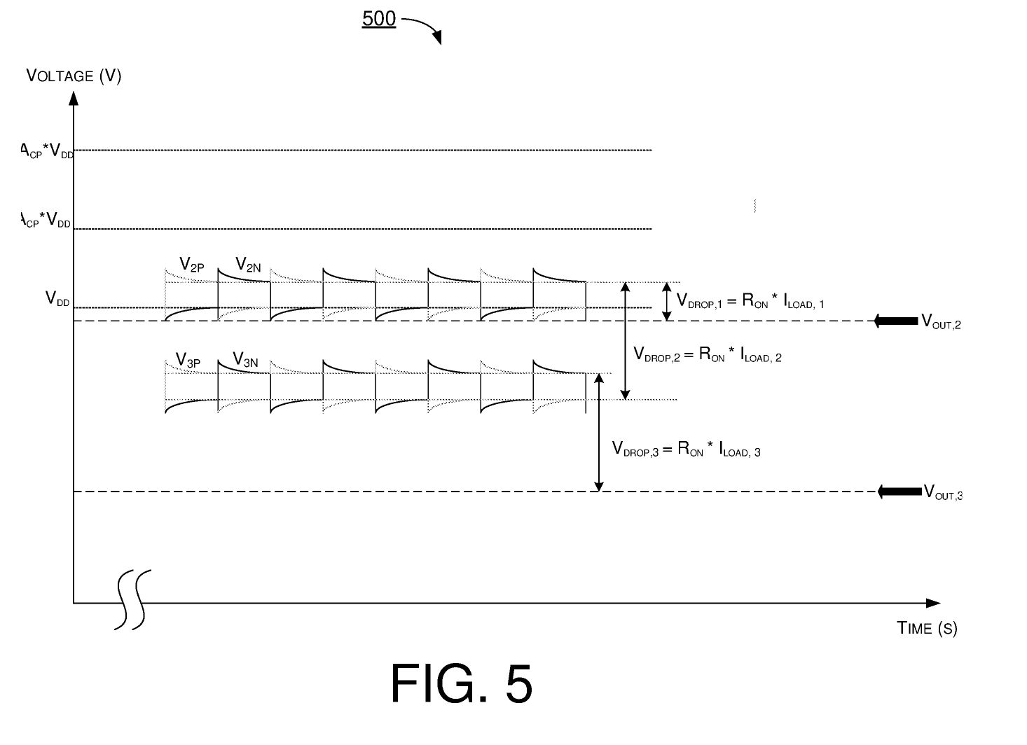

FIG. 5 illustrates another example scenario 500 of a time diagram for the internal and output voltages of the main charge pump under a higher load current condition without a booster. Referring to FIG. 5, in an event that the charge pump circuit is coupled to a load, very high load current may be generated for a few cycles. Compared to FIG. 4, the internal voltages (e.g., V_{2P}, V_{2N}, V_{3P} or V_{3N}) may have a lower amplitude than the internal voltages in the low load conditions. This is due to the discharge of the pumping capacitors impacting the voltage across plates (V = Q/C). This not only reduces the CP output voltage but also reduces the V_{gs} of the cross-coupled transistors. A consequence of lower V_{gs} may be the increase of Rₒₙ_{,} making the IR drop voltage V_{drop} more significant. Therefore, the third stage internal voltages (V_{3P} or V_{3N}) may sit at lower values than the second stage internal voltages (V_{2P} or V_{2N}).

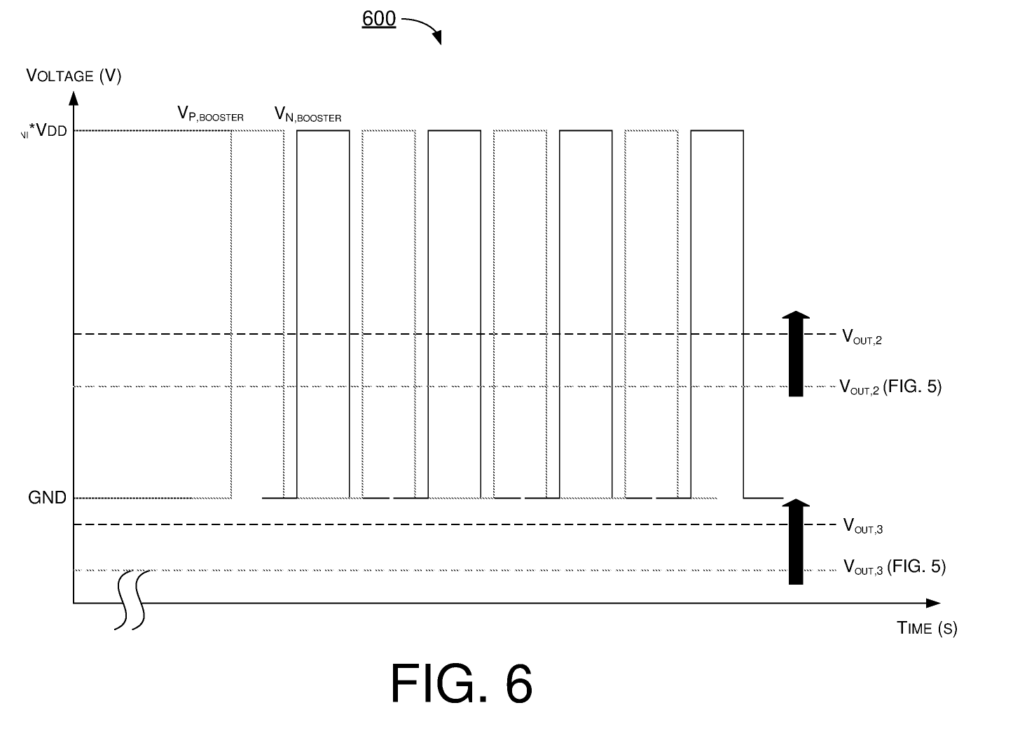

FIG. 6 illustrates an example scenario 600 of a time diagram for the booster control voltages and the effect on the main charge pump output voltages in which various solutions and schemes in accordance with the present disclosure may be implemented. Referring to FIG. 6, the booster voltage (e.g., V_{P}_{,} _{booster} or V_{N,}_{booster}) may be along with the internal voltages (e.g., V_{2P} or V_{2N}) and output of the main CP (i.e., the cross-coupled charge pumps of the charge pump circuit) (e.g., V_{out, 2} and V_{out, 3}). The booster signals or booster voltages (e.g., V_{P}_{,} _{booster} and V_{N,}_{booster}) should not overlap to avoid short circuits or charge loss. The high level of the booster voltage (e.g., V_{P}_{,} _{booster} or V_{N,}_{booster}) may be 4 * A_{CP, mini} * V_{DD}. The value of (4 * A_{CP, mini} * V_{DD}) may be at least the value of V_{out, 3} in an event that no load is coupled to the charge pump circuit. The value of A_{CP, mini} may be changed by adjusting the value of the capacitance C_{mini, pump}. Compared to FIG. 5, since the booster voltage (e.g., V_{P}_{,} _{booster} or V_{N,}_{booster}) can provide higher gate-source voltage (i.e., V_{gs}) for the NMOS of the booster transistor to reduce the IR drop on the equivalent resistor (e.g., Rₒₙ) of the main CP (i.e., the main cross-coupled charge pumps of the charge pump circuit), the main CP can recover faster. Specifically, when the load is connected via a switch, high current flows but only until the load charges (capacitive load), making the main charge pump output collapse. Accordingly, referring to FIG. 6, according to implementations of the present disclosure, the booster transistors of the charge pump circuit are introduced to speed up the recovery of the main CP. After the load has charged enough and the current is settling to an idle value, the booster transistors of the charge pump circuit can be disabled (as the booster burns power).

It should be noted that the inventions of the present disclosure can also be applied to a negative charge pump. That is, the NMOS transistors and PMOS transistors of the main charge pump circuit, the mini charge pump circuit, and the level shifter can be swapped and the pumping or flying capacitors can be flipped.

### Illustrative Processes

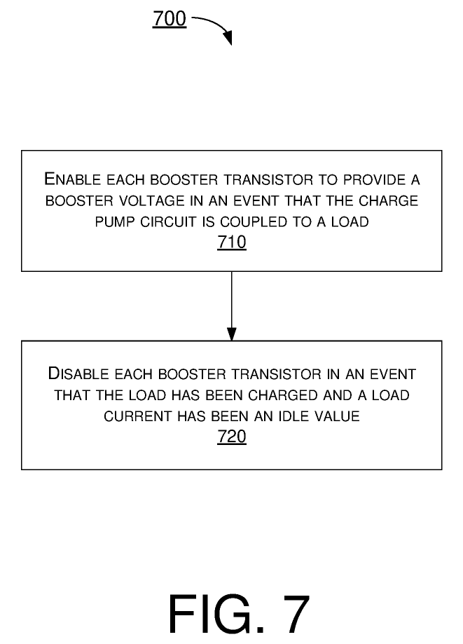

FIG. 7 illustrates an example process 700 in accordance with an implementation of the present disclosure. Process 700 may be an example implementation of above scenarios/schemes, whether partially or completely, with respect to charge pump boosting with the present disclosure. Process 700 may represent an aspect of implementation of features of charge pump circuit 100. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7or, alternatively, in a different order. Solely for illustrative purposes and without limitation, process 700 is described below in the context of charge pump circuit 100. Process 700 may begin at block 710.

At block 710, process 700 may involve charge pump circuit 100 enabling each booster transistor to provide a booster voltage in an event that the charge pump circuit is coupled to a load. Process 700 may proceed from block 710 to block 720.

At block 720, process 700 may involve charge pump circuit 100 enabling disabling each booster transistor in an event that the load has been charged and a load current has been an idle value.

In some implementations, each booster transistor may comprise an NMOS and receive the booster voltage from a level shifter.

In some implementations, the booster voltage may comprise an NMOS booster voltage or a PMOS booster voltage.

In some implementations, a gate-source voltage of the NMOS may be higher than a gate-source voltage of a transistor of the one or more stages of main charge pump coupled to the NMOS in an event that a gate of the NMOS is triggered by the booster voltage.

In some implementations, the level shifter may comprise a first PMOS, a second PMOS, a first NMOS, and a second NMOS. A source of the first PMOS may be coupled to a source of the second PMOS, a gate of the first PMOS and a drain of the second PMOS may be coupled to a drain of the second NMOS, a gate of the second PMOS and a drain of the first PMOS may be coupled to a drain of the first NMOS, and a source of the first NMOS may be coupled to a source of the second NMOS.

In some implementations, process 700 may involve the source of the first PMOS and the source of the second PMOS of the level shifter receiving an output voltage from a mini charge pump circuit. Process 700 may involve a gate of the first NMOS of the level shifter receiving a first clock signal. Process 700 may involve a gate of the second NMOS of the level shifter receiving a second clock signal. The first clock signal and the second signal may be out of phase.

In some implementations, process 700 may involve the level shifter outputting the booster voltage to the booster transistor according to the output signal, the first clock signal, and the second clock signal.

In some implementations, the mini charge pump circuit may comprise a plurality of stages of booster mini charge pump.

In some implementations, the number of the stages of booster mini charge pump may be more than the number of the one or more stages of main charge pump.

In some implementations, each capacitance of the stages of booster mini charge pump may be smaller than each capacitance of the one or more stages of main charge pump.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A charge pump circuit, comprising:
one or more stages of main charge pump, wherein each stage of main charge pump is coupled in series; and
a plurality of booster transistors, wherein each booster transistor is respectively coupled to each transistor of the one or more stages of main charge pump,
wherein each booster transistor is enabled based on a booster voltage in an event that the charge pump circuit is coupled to a load.

2. The charge pump circuit of claim 1, wherein each booster transistor comprises an N-channel metal-oxide-semiconductor field-effect transistor (NMOS) and receives the booster voltage from a level shifter.

3. The charge pump circuit of claim 2, wherein the booster voltage comprises an NMOS booster voltage or a P-channel metal-oxide-semiconductor field-effect transistor (PMOS) booster voltage.

4. The charge pump circuit of claim 2, wherein a gate-source voltage of the NMOS is higher than a gate-source voltage of a transistor of the one or more stages of main charge pump coupled to the NMOS in an event that a gate of the NMOS is triggered by the booster voltage.

5. The charge pump circuit of claim 2, wherein the level shifter comprises a first PMOS, a second PMOS, a first NMOS, and a second NMOS, wherein a source of the first PMOS is coupled to a source of the second PMOS, a gate of the first PMOS and a drain of the second PMOS are coupled to a drain of the second NMOS, a gate of the second PMOS and a drain of the first PMOS are coupled to a drain of the first NMOS, and a source of the first NMOS is coupled to a source of the second NMOS.

6. The charge pump circuit of claim 5, wherein the source of the first PMOS and the source of the second PMOS of the level shifter receive an output voltage from a mini charge pump circuit, a gate of the first NMOS of the level shifter receives a first clock signal, and a gate of the second NMOS of the level shifter receives a second clock signal, and wherein the first clock signal and the second signal are out of phase.

7. The charge pump circuit of claim 6, wherein the level shifter outputs the booster voltage to the booster transistor according to the output signal, the first clock signal and the second clock signal.

8. The charge pump circuit of claim 6, wherein the mini charge pump circuit comprises a plurality of stages of booster mini charge pump.

9. The charge pump circuit of claim 8, wherein a number of the stages of booster mini charge pump is more than a number of the one or more stages of main charge pump.

10. The charge pump circuit of claim 8, wherein each capacitance of the stages of booster mini charge pump is smaller than each capacitance of the one or more stages of main charge pump.

11. A charge pump boosting method, applied to a charge pump circuit, wherein the charge pump circuit comprises one or more stages of main charge pump and a plurality of booster transistors, wherein each stage of main charge pump is coupled in series, and wherein each booster transistor is respectively coupled to each transistor of the one or more stages of main charge pump, the method comprises:
enabling each booster transistor to provide a booster voltage in an event that the charge pump circuit is coupled to a load; and
disabling each booster transistor in an event that the load has been charged and a load current has been an idle value.

12. The charge pump boosting method of claim 11, wherein each booster transistor comprises a N-channel metal-oxide-semiconductor field-effect transistor (NMOS) and receives the booster voltage from a level shifter.

13. The charge pump boosting method of claim 12, wherein the booster voltage comprises an NMOS booster voltage or a P-channel metal-oxide-semiconductor field-effect transistor (PMOS) booster voltage.

14. The charge pump boosting method of claim 12, wherein a gate-source voltage of the NMOS is higher than a gate-source voltage of a transistor of the one or more stages of main charge pump coupled to the NMOS in an event that a gate of the NMOS is triggered by the booster voltage.

15. The charge pump boosting method of claim 12, wherein the level shifter comprises a first PMOS, a second PMOS, a first NMOS, and a second NMOS, wherein a source of the first PMOS is coupled to a source of the second PMOS, a gate of the first PMOS and a drain of the second PMOS are coupled to a drain of the second NMOS, a gate of the second PMOS and a drain of the first PMOS are coupled to a drain of the first NMOS, and a source of the first NMOS is coupled to a source of the second NMOS.

16. The charge pump boosting method of claim 15, further comprising:
receiving, by the source of the first PMOS and the source of the second PMOS of the level shifter, an output voltage from a mini charge pump circuit;
receiving, by a gate of the first NMOS of the level shifter, a first clock signal; and
receiving, by a gate of the second NMOS of the level shifter, a second clock signal, and wherein the first clock signal and the second signal are out of phase.

17. The charge pump boosting method of claim 16, further comprising:
outputting, by the level shifter, the booster voltage to the booster transistor according to the output signal, the first clock signal and the second clock signal.

18. The charge pump boosting method of claim 16, wherein the mini charge pump circuit comprises a plurality of stages of booster mini charge pump.

19. The charge pump boosting method of claim 18, wherein a number of the stages of booster mini charge pump is more than a number of the one or more stages of main charge pump.

20. The charge pump boosting method of claim 18, wherein each capacitance of the stages of booster mini charge pump is smaller than each capacitance of the one or more stages of main charge pump.
